(19) United States
(12) Patent Application Publication
(10) Pub. No.: US 2010/0127835 A1
(43) Pub. Date: May 27, 2010

(54) METHOD AND APPARATUS FOR SELECTIVELY FACILITATING ACCESS TO RFID DATA

(75) Inventor: Itzhak POMERANTZ, Kfar Saba (IL)

Correspondence Address: BRINKS HOFER GILSON & LIONE/SanDisk, P.O. BOX 10395, CHICAGO, IL, 60610, US

(73) Assignee: SanDisk IL Ltd., Kfar Saba (IL)

(21) Appl. No.: 12/323,487

(22) Filed: Nov. 26, 2008

(51) Int. Cl. H04Q 5/22

(52) U.S. Cl. 340/10.3

(57) ABSTRACT

Methods and apparatus for selectively facilitating access to RFID data of one more RFID tags within a faraday cage are disclosed herein. In some embodiments, (i) an external RFID interrogation signal is received (for example, by one more external antennae deployed outside of the faraday cage; (ii) a determination is made if access to RFID data of one more RFID tags within the faraday cage is permitted; and (iii) contingent on the determining that access from outside of the faraday cage is permitted, access is provided to RFID data of one or more RFID tag(s) within the faraday cage. This access providing may include the steps of: i) in response to the received external RFID interrogation signal, interrogating inside the faraday the cage one or more RFID tags; ii) receiving an RFID response from one or more of the interrogated RFID tags; and iii) transmitting to outside the faraday cage the received RFID response.

### FIELD OF THE INVENTION

The present invention relates to data security, and to techniques and apparatus for providing selective access to RFID data of RFID tags.

### BACKGROUND

Radio-frequency identification (RFID) is an automatic identification method, relying on storing and remotely retrieving data using devices called RFID tags or transponders. The technology requires some extent of cooperation of an RFID reader and an RFID tag.

An RFID tag is an object that can be applied to or incorporated into a product, animal, or person for the purpose of identification and tracking using radio waves. Some tags can be read from at least several meters away and beyond the line of sight of the reader.

RFID tags contain at least two parts. One is an integrated circuit for storing and processing information, modulating and demodulating a radio-frequency (RF) signal, and other specialized functions. The second is an antenna for receiving and transmitting the signal.

When RFID tags receive an “interrogation signal,” they respond to the interrogation signal by transmitting a radio signal indicative of RFID data stored in the integrative circuit.

Interrogatable RFID tags come in two general varieties—passive and active or semi-passive types (also known as battery-assisted or semi-active). Passive tags require no internal power source, thus being pure passive devices (they are only active when a reader is nearby to power them by wireless illumination), whereas semi-passive and active tags require a power source, usually a small battery.

A concern surrounding RFID that has received considerable publicity is the issue of privacy. Because certain RFID tags may in theory be scanned and read from distances exceeding several meters, and because RFID utilizes an assortment of frequencies (both depending on the type of tag, though), there is some concern over whether sensitive information could be collected from an unwilling source. Thus, in many situations, RFID tags stored in the user's wallet or pocket may be read without the user's knowledge or consent.

There is an ongoing need for methods and apparatus for regulating access to RFID data stored on RFID tags, thereby reducing the privacy hazard associated with many RFID tags.

### SUMMARY OF EMBODIMENTS

Various embodiments address these and related issues, examples of which embodiments, including methods and systems, are provided herein. One embodiment is a method of selectively facilitating access to RFID data. The method comprises the steps of: a) determining if access to RFID data of one or more RFID tags located in a faraday cage from outside of the faraday cage is permitted; b) receiving an external RFID interrogation signal; and c) contingent on determining that the access from outside of the faraday cage is permitted, providing access to the RFID data by: i) in response to the received external RFID interrogation signal, interrogating inside the faraday the cage one or more RFID tags; ii) receiving an RFID response from one or more of the interrogated RFID tags; and iii) transmitting to outside the faraday cage the received RFID response.

There is no limitation on the time that the determining may be carried out. Thus, in different embodiments, the determining may be carried out before or in response to the receiving of the external RFID interrogation signal.

A number of techniques are disclosed for determining if access to RFID data of one or more RFID tags located in a faraday cage from outside of the faraday cage is permitted.

In one embodiment, the determining includes authenticating an RFID reader external to the Faraday cage from which the external RFID interrogation signal is received, and a positive determining is contingent on a successful authenticating of the RFID reader.

In some embodiments, the determining is carried out in accordance a location of the Faraday cage and/or a time and/or a date and/or an ambient environmental factor (for example, temperature, humidity or any other factor).

In some embodiments, the method further includes c) effecting a permitted-forbidden access mode change in response to at least one of: i) detecting an outgoing phone call; ii) detecting an outgoing text message; iii) detecting an incoming phone call; and iv) detecting an incoming text message, wherein the determining is carried out in accordance with the changed permitted-forbidden access mode.

The determining may be carried out selectively on a per-tag basis in accordance with RFID data. Alternatively, the determining may be carried out in a manner that is insensitive to a tag identifier.

A number of techniques whereby the determining is carried out “selectively” on a per-tag basis in accordance with RFID data are disclosed herein. In some embodiments, the determining includes, for a given RFID reader, permitting access to a first sub-set of a plurality of RFID tags located in the faraday cage, and forbidding access to a second sub-set of the plurality of RFID tags located in the faraday cage.

In some embodiments where the determining is carried out “selectively,” for a given RFID tag located in the faraday cage, the determining is carried out in accordance with a relationship between an identity of the given RFID tag and an identity of an RFID reader external to the faraday cage from which the external RFID interrogation signal is reached.

In one example related to these embodiments, i) the method further comprises: d) in the event that the external RFID interrogation signal is directed to a given one or more RFID tags within the faraday cage, soliciting an RFID reader identifier from a source of the external RFID interrogation signal; and ii) the determining of step (a) is carried out in a manner that is contingent upon receiving, in response to the soliciting, an RFID reader identifier that matches a set of permitted RFID readers for the given one or more RFID tags.

Thus, in some embodiments, the determining is carried out in accordance of an identifier of an RFID reader from which the external RFID interrogation signal is received. Alternatively, the determining is carried out in a manner that is insensitive to an identifier of an RFID reader from which the external RFID interrogation signal is received.

In some embodiments, the determining of whether RFID data of a particular RFID tag (or any arbitrary RFID tag within the faraday cage) is permitted or forbidden from outside of the faraday cage is carried out in accordance with input received from a user (for example, via a keypad or a microphone of a mobile telephone).

Thus, in one example, the method further includes, d) effecting a permitted-forbidden access mode change in response to a receiving of user input via one or more user controls, wherein the determining is carried out in accordance with the changed permitted-forbidden access mode. The mode change may be “specific” and carried out only for specific set of tags, or may be “general” and may be carried out for any arbitrary RFID tag within the faraday cage.

The user input may be received at any time. In one example, the user is “prompted” for input in response to the receiving, by an antenna array outside of the faraday cage, of the external RFID interrogation signal. Thus, in this embodiment, (i) the method further comprises: d) in response to the received external RFID interrogation signal, soliciting user input from a user; and (ii) the determining of step is carried out in accordance with the solicited user input.

In some embodiments, the method further comprises: (d) determining an inventory of one or more RFID tags residing within the faraday cage; and c) presenting to a user a description of the inventory.

Different apparatus for implementing the aforementioned method are disclosed herein. In some embodiments, i) the interrogating, inside the faraday cage, includes transmitting an internal interrogation signal to one or more of the RFID tags within the faraday cage using an internal antenna assembly; and ii) the response receiving is carried out using the internal antenna assembly.

Alternatively, the interrogating inside the faraday cage and the response receiving are carried out using a device port that is: i) deployed internally within the faraday cage; and ii) wired to one or more of the RFID tags.

Another embodiment is an apparatus for selectively facilitating access to RFID data, the apparatus comprising: a) a faraday cage operative to store one or more RFID tags; b) an external antenna assembly operative to receive an external RFID interrogation signal, at least a portion of the external antenna assembly being deployed outside of the faraday cage; c) an internal communication element selected from the group consisting of: i) an internal antenna assembly, at least a portion of the internal antenna assembly deployed within the faraday cage; and ii) an internal device port deployed within the faraday cage, and d) control circuitry operative to: A) determine if access to RFID data of one or more RFID tags located in the faraday cage is permitted or forbidden; and B) contingent on results of the determining, and in response to the received external RFID interrogation signal received via the external antenna assembly I) interrogate, inside of the faraday cage, one or more RFID tags that are located within the faraday cage using the internal communication element; II) receive, within the faraday cage, an RFID response from one or more of the internally interrogated RFID tags via the internal communication element; and III) transmit to outside of the faraday cage, the RFID response using the external antenna assembly.

In some embodiments, the control circuitry includes at least one of software and firmware.

In some embodiments, the control circuitry is operative such that the determining includes authenticating an RFID reader located outside of the faraday cage, and a positive determining is contingent on a successful authenticating of the RFID reader.

In some embodiments, the control circuitry is operative such that the determining is carried out in accordance with at least one of: i) a location of the Faraday cage; ii) a time; iii) a date; and iv) an ambient environmental factor

In some embodiments, i) the control circuitry is further operative to effect a permitted-forbidden access mode change (i.e. either for a specific set of one or more tags, or for any arbitrary tag in the faraday cage) in response to at least one of: A) detecting an outgoing phone call; B) detecting an outgoing text message; C) detecting an incoming phone call; and D) detecting an incoming text message; and ii) the control circuitry is operative such that the determining is carried out in accordance with the changed permitted-forbidden access mode.

In some embodiments, the control circuitry is operative to effect the determining selectively on a per-tag basis in accordance with RFID data.

In some embodiments, for a given RFID tag located in the faraday cage, the control circuitry is operative to carry out the determining in accordance with a relationship between an identity of the given RFID tag and an identity of an RFID reader located outside of the faraday cage from which the external RFID interrogation signal is reached.

In some embodiments, wherein: i) the control circuitry is further operative: C) in the event that the external RFID interrogation signal is directed to a given one or more RFID tags within the faraday cage, to solicit an RFID reader identifier from a source of the external RFID interrogation signal; and ii) the control circuitry is operative to effect determining of step (A) in a manner that is contingent upon receiving, in response to the soliciting, an RFID reader identifier that matches a set of permitted RFID readers for the given one or more RFID tags.

In some embodiments, the control circuitry is operative such that the determining includes, for a given RFID reader, permitting access to a first sub-set of a plurality of RFID tags located in the faraday cage, and forbidding access to a second sub-set of the plurality of RFID tags located in the faraday cage.

In some embodiments, the control circuitry is operative to effect the determining in a manner that is insensitive to a tag identifier.

In some embodiments, the control circuitry is operative to effect the determining in a manner that is insensitive to an identifier of an RFID reader from which the external RFID interrogation signal is received.

In some embodiments, the apparatus further comprises: d) at least one user input device selected from the group consisting of a keyboard and a microphone, the at least one user input device configured to receive user input, wherein: i) the control circuitry is operative to effect a permitted-forbidden access mode change in response to a receiving of the user input via one or more of the user input devices; and ii) the control circuitry is operative such that the determining is carried out in accordance with the changed permitted-forbidden access mode.

In some embodiments, the control circuitry is operative, upon receiving tag-specific user input via one or more of the user input devices, to effect the access mode change only for the set of one or more tags specified in the tag-specific user input.

In some embodiments, i) the apparatus comprises the internal antenna assembly; ii) the control circuitry is operative to effect the internal interrogation using the internal antenna assembly; iii) the control circuitry is operative to receive the RFID response via the internal antenna assembly.

In some embodiments, i) the apparatus comprises the internal device port; ii) the control circuitry is operative to effect the internal interrogation using the internal device port; iii) the control circuitry is operative to receive the RFID response via the internal device port.

It is noted that features described above as pertaining to certain embodiments may also be included in other embodiments, unless indicated to the contrary herein below.

### BRIEF DESCRIPTION OF THE DRAWINGS

FIGS. 1, 2B, and 6 are block diagrams of apparatus for facilitating access from outside of a faraday cage to RFID of RFID tag(s) located within the faraday cage in accordance with some embodiments.

FIGS. 2A, 2C are flow charts of routines for facilitating access from outside of a faraday cage to RFID data of RFID tag(s) located within the faraday cage in accordance with some embodiments.

FIGS. 3-5 are flow charts of routines for determining if access from outside of a faraday cage to RFID of RFID tag(s) located within the faraday cage is permitted in accordance with some embodiments.

FIG. 7 illustrated various elements which may be provided as a part of and/or may be operatively linked with RFID access-regulator.

### DETAILED DESCRIPTION OF EMBODIMENTS

The claims below will be better understood by referring to the present detailed description of example embodiments with reference to the figures. The description, embodiments and figures are not to be taken as limiting the scope of the claims. It should be understood that not every feature of the presently disclosed methods and apparatuses is necessary in every implementation. It should also be understood that throughout this disclosure, where a process or method is shown or described, the steps of the method may be performed in any order or simultaneously, unless it is clear from the context that one step depends on another being performed first. As used throughout this application, the word “may” is used in a permissive sense (i.e., meaning “having the potential to”), rather than the mandatory sense (i.e. meaning “must”).

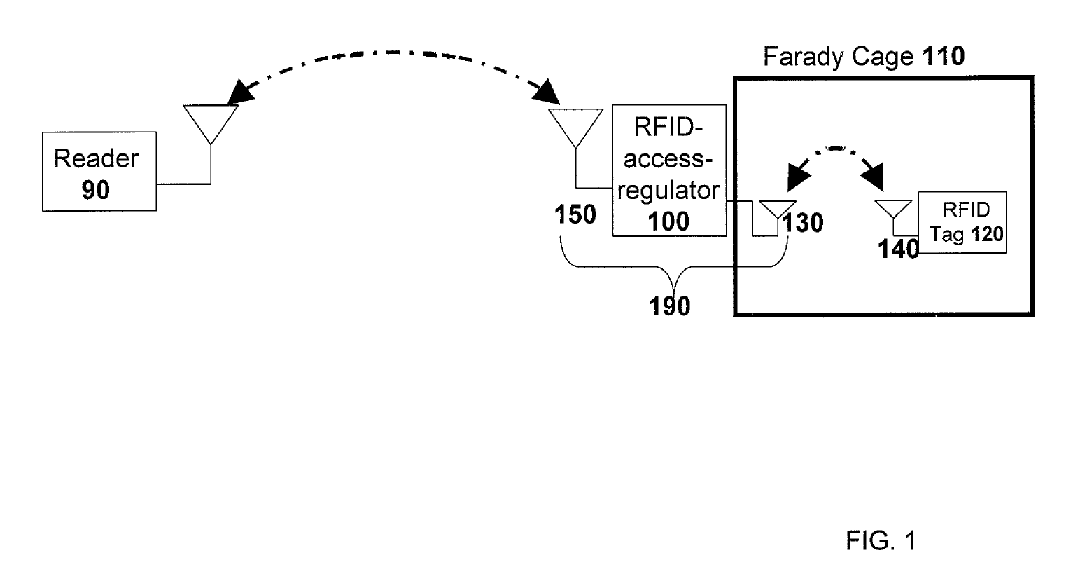

### A Discussion of FIG. 1

Embodiments of the present invention relate to an apparatus and method for selectively facilitating access to one or more RFID tags 120 located within faraday cage 110. Faraday cage 110 substantially shields RFID tag(s) from an incoming interrogation signal transmitted by RFID reader 90. Nevertheless, interrogation of RFID tag 120 by RFID reader 90 is possible when RFID relay 190: (i) receives the RFID interrogation signal using external antenna assembly 150 located outside of the faraday cage 110; (ii) relays the RFID interrogation signal to RFID tag 120 using internal antenna assembly 130 located inside of faraday cage 110; (iii) receives, using internal antenna assembly 130 the response to the RFID interrogation signal; and (iv) transmits the received RFID response outside of faraday cage 110 using external antenna assembly 150.

Thus, RFID relay 190 is operative to allow access to RFID data of RFID tag 120 which is located within faraday cage. However, in some embodiments, this access is not unconditional, and is only provided if RFID access-regulator 100 determines that access to RFID data of one or more RFID tag(s) 120 within faraday cage is permitted.

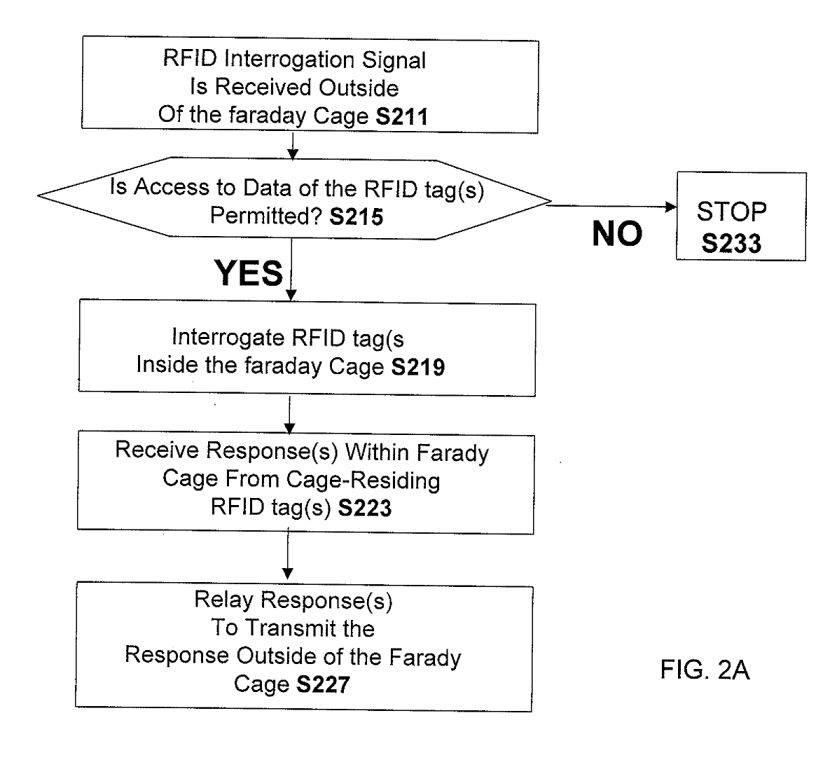

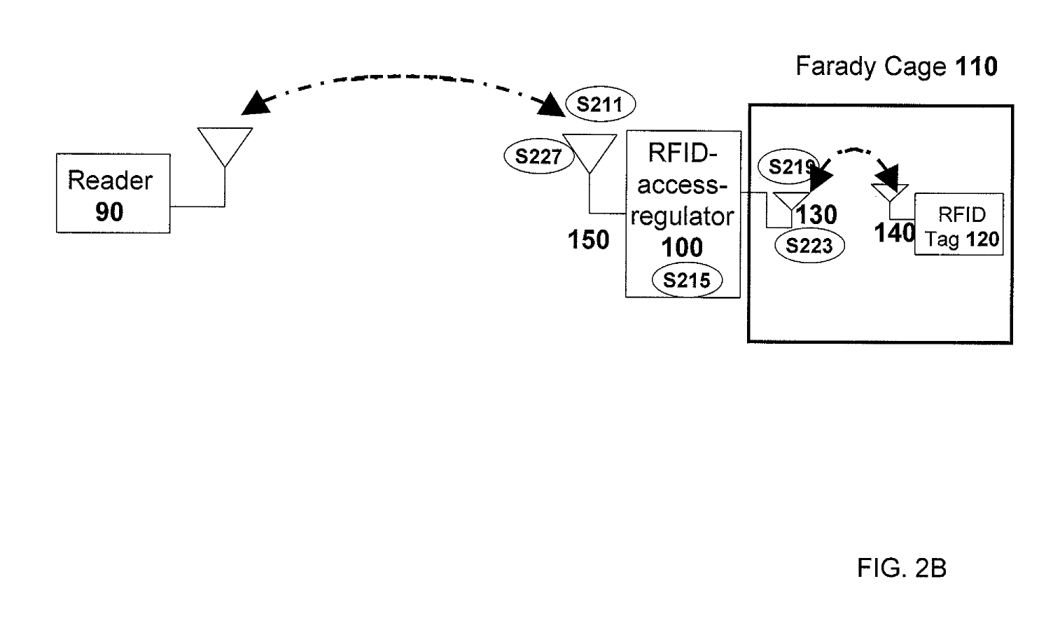

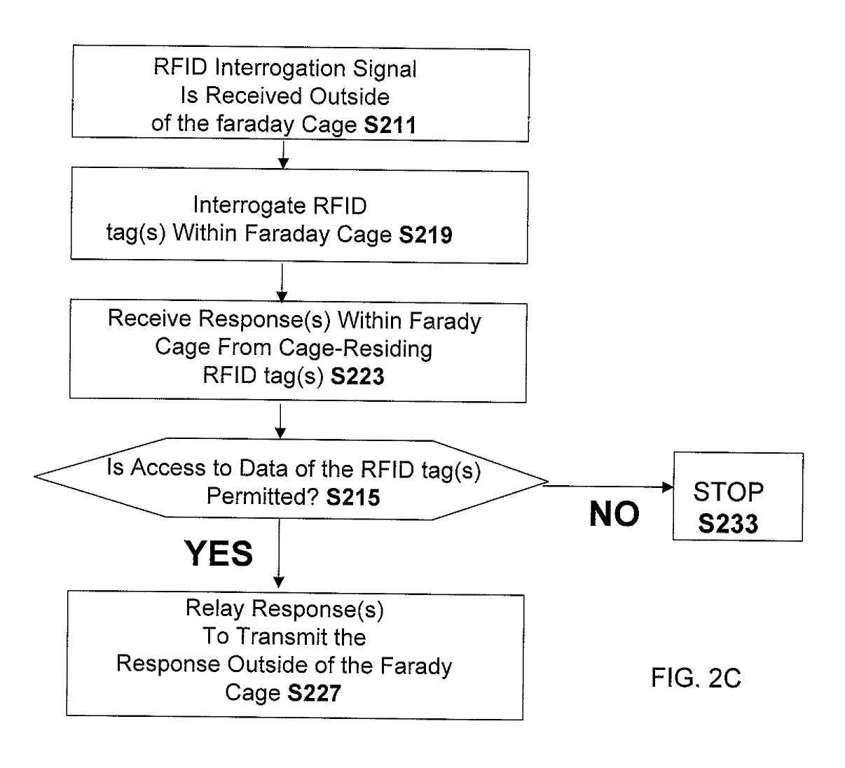

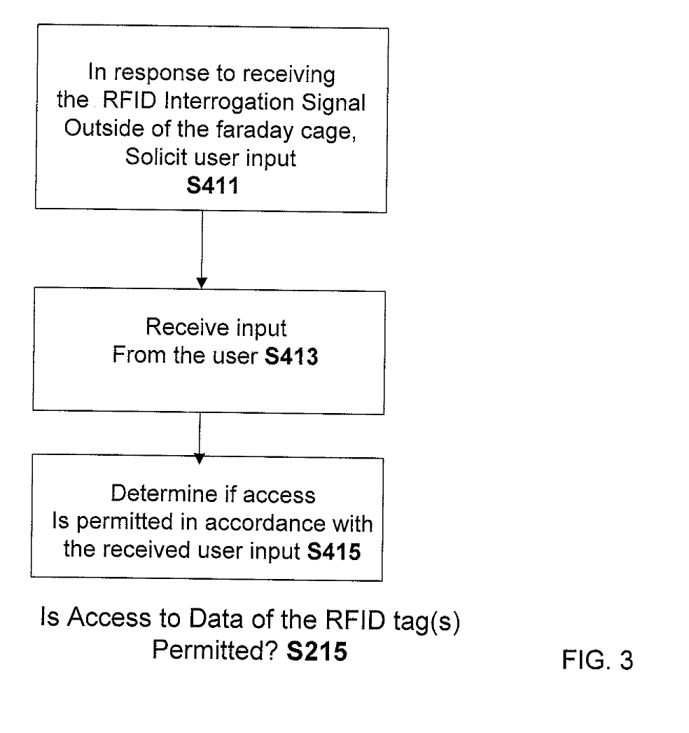

In different non-limiting use cases, access to RFID data of one or more tags may be permitted by RFID access-regulator 100 only at a certain time of the day, or only when faraday cage 110 is located in a certain geographic location (for example, within 200 meters of a certain location, for example, within 200 meters of corporate headquarters of XYZ corp.), or only for certain authenticated RFID readers or only upon manual authentication using a data input device (i.e. for example, a keyboard for entering a password). Other non-limiting examples of “criteria” for determining whether or not access to RFID data of one or more tags 120 are described below (see, for example, step S215 of FIGS. 2A, 2C and see the discussions of FIGS. 3-5, 7).

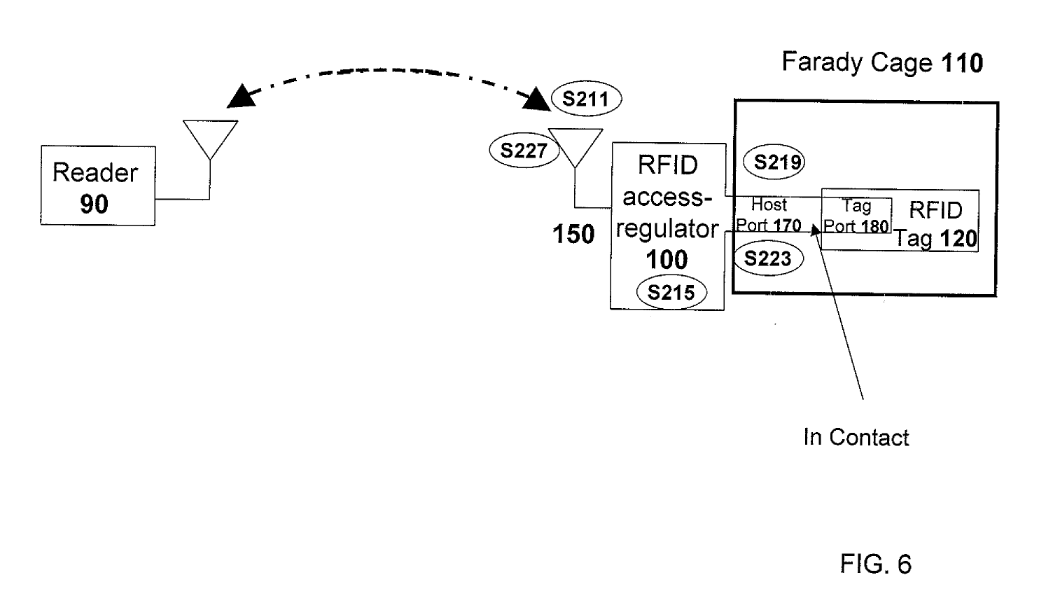

As illustrated in FIG. 1, RFID tag 120 may be removed from faraday cage 110 and used independently. Thus, in some embodiments, the system illustrated in FIG. 1 is useful for providing “selective privacy” for RFID tag(s) such that RFID data of the RFID tag(s) nay only be read if certain conditions are met. This allows for regulating access to RFID data in a manner that does not require modification of the RFID tag itself—i.e. the system of FIG. 1 or FIG. 6 may be used with “ordinary” RFID tags not requiring any special modifications.

Although not a limitation, in some embodiments, faraday cage 110 is a “handheld faraday cage.” In one particular non-limiting example, (i) RFID-access-regulator 100 is operatively linked to a mobile telephone and/or (ii) faraday cage 100 is mechanically integrated with a mobile telephone—for example, a “closed compartment” of the mobile phone.

It is noted that RFID access regulator 100 may include may include any executable code module (i.e. stored on a computer-readable medium) and/or firmware and/or hardware element(s) including but not limited to field programmable logic array (FPLA) element(s), hard-wired logic element(s), field programmable gate array (FPGA) element(s), and application-specific integrated circuit (ASIC) element(s). Any instruction set architecture may be used RFID access regulator 100 including but not limited to reduced instruction set computer (RISC) architecture and/or complex instruction set computer (CISC) architecture.

### Discussion of FIG. 2A

FIGS. 2A and 2C are flow charts of exemplary techniques for selectively facilitating access to RFID data. FIG. 2B visually associates various steps of FIG. 2A with elements of the system of FIG. 1. In one embodiment, the techniques described in FIGS. 2A, 2C may be carried out by the system of FIG. 1. In yet another embodiment, the techniques described in FIGS. 2A-2B may be carried out by the system of FIG. 6, which is discussed below.

Reference is now made to FIGS. 2A-2B. In step S211, an RFID interrogation signal is received from RFID reader 90 by external antenna assembly 150. In step S215, a determination may be made (for example, by RFID access-regulator 100) as to whether or not access to RFID data of one or more of the RFID tag(s) is “permitted” or “forbidden.” Various examples of how to make this determination are described throughout the present disclosure—see, for example, see the discussions of FIGS. 3-5, 7.

In the event that access is not permitted, no further action is required, as indicated in step S233.

In the event that access is permitted, one or more of the RFID tag(s) 120 are interrogated inside the fade cage, during step S219. For example, internal assembly may re-transmit the RFID interrogation signal (i.e. which was previously received in step S211) within faraday cage 110. This interrogation signal (i.e. which is transmitted inside faraday cage 110 by internal antenna assembly 130) may then be received by one more RFID tag(s) 120, which responds by transmitting a response signal using antenna 140. The response signal may then be received, in step S223, by internal antenna assembly 130.

In step S227, the response signal (i.e. which was transmitted by the RFID tag(s) within faraday cage 110 and then received by internal antenna assembly 130 in step S223) is transmitted outside of faraday cage S227, for example, by external antenna assembly 150. This relayed RFID response signal may then be received by RFID reader 90.

FIG. 2B illustrates allow steps of FIG. 2A as performed by the system of FIG. 1.

FIG. 2C is a flow chart of an alternative technique for selectively facilitating access to RFID data. In the example of FIG. 2A, the RFID interrogation signal received outside of the cage is only relayed to the RFID tag(s) 120 if access to the RFID tag(s) is permitted. In some alternate embodiments related to FIG. 2C, the interrogation signal may be relayed into the faraday cage 110 even if access to RFID data of the RFID tag(s) 120 is forbidden. However, in these alternate embodiments, in the event that access to RFID data of the tag(s) 120 is forbidden, the response to the RFID interrogation signal transmitted by the RFID tag(s) 120 is only relayed outside of the faraday cage 110 if access to the RFID data is permitted.

It is noted the order of steps in FIGS. 2A, 2C is only provided as one example, and is not limiting. In some embodiments, the determining of step S215 is carried out after the receiving of the RFID signal of step S211, as illustrated in FIGS. 2A-2B. In one example, the determining of step S215 is carried out in response to the signal receiving of step S211. In an alternate embodiment, the determining of step S215 may be carried out before the receiving of the RFID signal of step S211.

### DEFINITIONS

For convenience, in the context of the description herein, various terms are presented here. To the extent that definitions are provided, explicitly or implicitly, here or elsewhere in this application, such definitions are understood to be consistent with the usage of the defined terms by those of skill in the pertinent art(s). Furthermore, such definitions are to be construed in the broadest possible sense consistent with such usage.

A ‘faraday cage’ is an enclosure formed by conducting material, or by a mesh of such material, which can shield the interior from external electromagnetic radiation if the conductor is thick enough and any holes are significantly smaller than the radiation's wavelength.

The faraday cage may reduce the amplitude of a signal at normal operating RFID frequencies (i.e. 860 MHz to 960 MHz and 2.4 GHz to 2.5 GHz) by at least 95%—i.e. the signal received within the Faraday cage has an amplitude that is at most 5% of the amplitude of the signal received outside of the Faraday cage.

A “handheld” faraday cage is a faraday cage that may be held by a user, and has (i) a longest dimension that is less than 20 centimeters; and (ii) a volume that is less than 1000 cm̂3. In some embodiments, the handheld faraday cage has (i) a longest dimension that is less than 10 centimeters; and (ii) a volume that is less than 300 cm̂3.

An “external” RFID interrogation signal is an RFID interrogation signal received outside of faraday cage 110, for example, by external antenna array 150. An “internal” RFID interrogation signal is an interrogation signal transmitted within faraday cage 110 for example, by internal antenna array 130.

“RFID data” of a particular RFID tag is data identifying the particular RFID tag which is stored in the integrated circuit of the RFID tag.

An “antenna array” (for example, external antenna array 150 or internal antenna array 130) is an array of one or more antennae. If two steps (for example, a receiving and a transmitting of a radio signal) are carried out by the same antenna array, it is possible that: (i) both steps (i.e. both transmitting and receiving) are carried out by the same antenna of the antenna array; and/or (ii) a first step is carried out by one antenna of the antenna array, a second step is carried out by a different antenna of the antenna array.

### A Discussion of FIG. 3

FIG. 3 is a flow chart of an exemplary routine for determining whether access from outside of the faraday cage to RFID data of one or more RFID tag(s) is permitted or forbidden in accordance with user input—i.e. one possible implementation of step S215 of FIGS. 2A, 2C is presented in FIG. 3.

In step S411, user input is solicited in response to a receiving of the RFID interrogation signal. In one non-limiting example related to a particular case where the RFID repeater 190 is associated with a mobile phone, a mobile phone screen may display, in response to the received interrogation signal, information indicating that the external RFID interrogation signal has been received. A message prompting the user if s/he permits the reading of all RFID tag(s) within faraday cage 110 and/or one or more specified RFID tag(s) may be displayed. Alternatively or additionally, a noise may be produced or the phone may vibrate to “prompt the user” for input.

In step S413, input is received from the user. For example, the user may press on or more user control(s) and/or type in information and/or provide “voice input” to a microphone. In one example, the user may provide instructions listing which particular RFID tags are permitted. In another example, the user may input instructions permitting access to RFID data from outside faraday cage 110 for any RFID tag within faraday cage 110.

In step S415, it is determined if “read access” from outside of the faraday cage should be provided for all tags in the cage and/or one or more specified tag(s) is permitted in accordance with the user input received in step S413. In one example, if the user says the word “yes” in the microphone in step S413, then there is a “positive” determining in step S415 that access from outside of the faraday cage to the RFID tag(s) is permitted.

In another example, a menu is presented in step S411 for example, including a “yes or no” option. In this example, in step S415, it is determined if access is permitted according to whether or not the user selected “yes” or “no” in step S413.

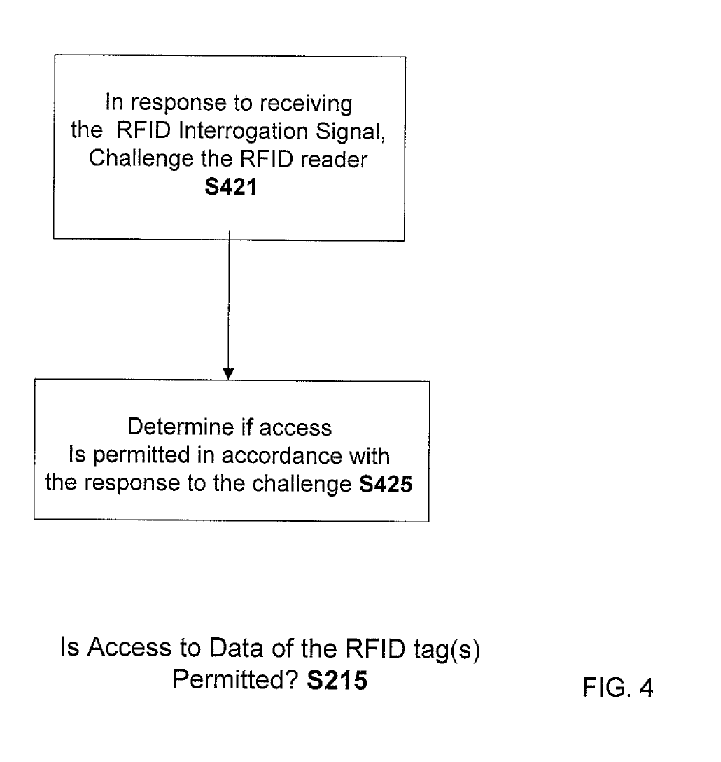

### A Discussion of FIG. 4

FIG. 4 is a flow chart of an exemplary routine for determining whether access from outside of the faraday cage to RFID data of one or more RFID tag(s) is permitted or forbidden in accordance with user input—i.e. one possible implementation of step S215 of FIGS. 2A, 2C is presented in FIG. 4.

In step S421, a challenge is transmitted to RFID reader 90 in response to the receiving of the RFID interrogation signal (i.e. in step S211 of FIGS. 2A, 2C) by external antenna assembly 150. In step S425, a determination is made if access is permitted in accordance with the response to the challenge (for example, only if the reader 90 “successfully” responds to the challenge is access permitted).

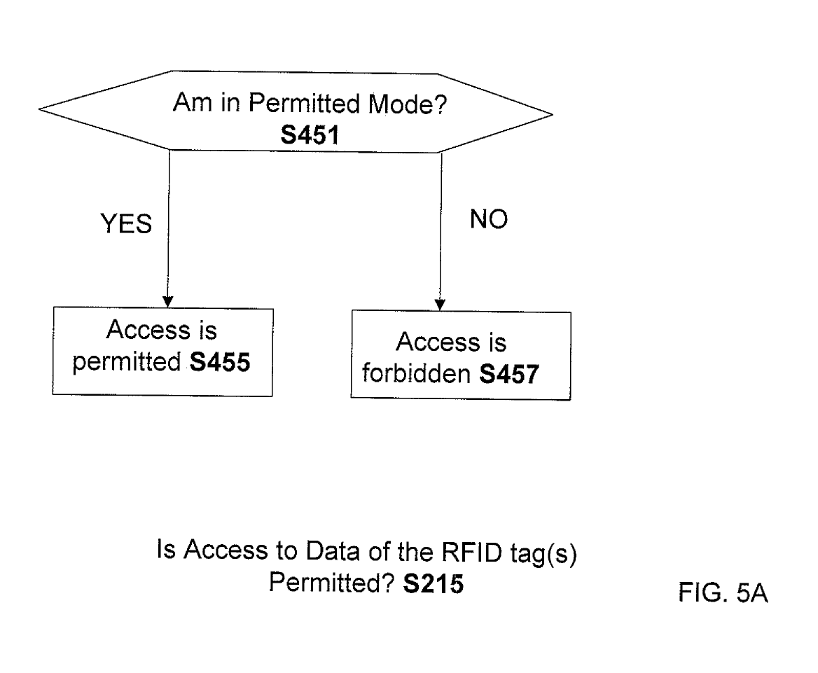

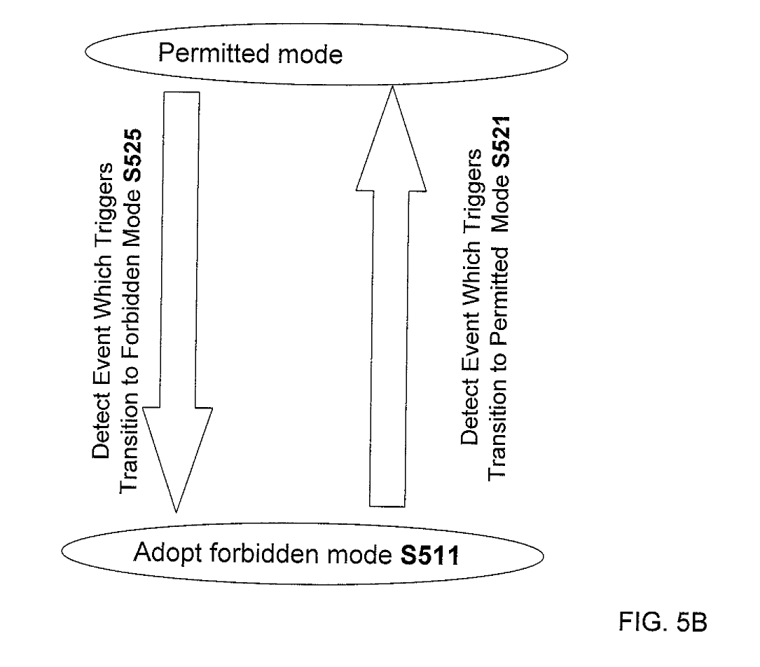

### A Discussion of FIGS. 5A-5B

In some embodiments, RFID access-regulator 100 may have two modes: (i) a first mode when access is permitted (i.e. to a specific set of one or more RFID tag(s) or, non-specifically, to any tag within faraday cage 110) and (ii) a second mode when access is forbidden.

Thus, in step S451, it is determined if RFID access-regulator 100 is in “permitted mode.” If RFID access-regulator 100 is in “permitted mode,” then access is permitted in step S455, and the “yes” branch leaving step S215 is selected in step S455. Otherwise, access is forbidden in step S457, and the “no” branch leaving step S215 is selected in step S457.

In some embodiments, in response to “detecting an event,” RFID access-regulator 100 may transition between “permitted mode” and “forbidden mode.” In one non-limiting example, in response to a detection of an incoming SMS, RFID access-regulator 100 may ‘transition’ from “forbidden” to “permitted” mode (i.e. for a specific set of RFID tag(s) or ‘in general’ for any arbitrary RFID tag within faraday cage 110). According to this non-limiting example, after effecting this ‘mode transition’ RFID access-regulator 100 “remains” in “permitted mode” only for a pre-determined amount of time (for example, 10 minutes), and then automatically “transitions back” to forbidden mode after the pre-determined amount of time.

This is illustrated in FIG. 5B, where in step S521 is a transition from “forbidden mode” to “permitted mode” in response to one type of event and step S525 is a transition from “permitted mode” to “forbidden mode” in response to another type of event.

The “triggering” events may include any type of events, including but not limiting to;
(i) an outgoing or incoming phone call or message;
(ii) that passing of a given amount of time since an earlier event;
(iii) receiving specific input from a user;
(iv) motion of the faraday cage 110 or any other object to or from a location or area;
(v) an increase or decrease in ambient temperature; and/or
(vi) the receiving of input from a user (for example, provided by a keypad of a mobile phone).

### A Discussion of FIG. 6

FIG. 6 is a block diagram of an alternate system for facilitating access to RFID data of RFID tag(s) within a faraday cage 110. The system of FIG. 6 is the same as the system of FIG. 1, with the exception that the system of FIG. 6 does not utilize an internal antenna array 130 to relay the RFID interrogation signal received by external antenna array 150 to RFID tag 120. Instead, in the system of FIG. 6, external antenna array 150 and RFID access-regulator 100 are electrically connected to RFID tag 120 host-side port 170 (which is connected to faraday cage 110) and ‘device-side’ tag port 180 which is part of RFID tag 120 and may be integrally formed with RFID tag 120.

RFID tag 120 may be disconnected from host port 170, removed from faraday cage 110, and used as ‘independently’ as an RFID tag.

In different embodiments, ports 170 and 180 may have any shape and may support any protocol. Exemplary port types including but not limited to USB, MMC and SD.

### Determining if Assess to RFID Data of an RFID Tag(s) in Accordance With Tag Identity

As noted earlier, in some embodiments, the determining of step S215 is carried out “arbitrarily” for any RFID tag within faraday cage 110 and in a manner that is ‘insensitive’ to tag identifier.

Alternatively, the determining of step S215 may be carried out in accordance with tag identifier. In one non-limiting example, tags A, B and C are located within faraday cage 110. In this example, RFID access-regulator is configured so that (i) access to data of tag A from outside of faraday cage 110 is permitted between 9 AM and 11 AM and forbidden at other times; (ii) access to data of tag B from outside of faraday cage 110 is permitted between 10 AM and 11:30 AM and forbidden at other times; (ii) access to data of data C from outside of faraday cage 110 is always permitted.

According to this non-limiting example, when an RFID interrogation signal is received at 9:30 AM, RFID relay 190 (i) is operative to relay the external RFID interrogation signal to tag A and to transmit, outside of faraday cage 110, the response provided by tag 110; and (ii) to not provide this functionality for tag B.

According to this example, at 9:30 AM, access to a first subset {A, C} of the set of all RFID tags within faraday cage {A,B,C} is permitted, while access to a second subset {B} of the set of all RFID tags within faraday cage {A,B,C} is forbidden.

This may be implemented in a number of ways. In one example, the external RFID interrogation signal includes information indicative of the “target RFID tag” which is “targeted” by the external RFID interrogation signal. This information may be utilized by RFID access-regulator in effecting the determination in step S215.

Alternatively or additionally, in another example, the RFID interrogation signal is always related into faraday cage 110, and the content of the RFID response from RFID tag 120 (which describes an identity of the RFID tag interrogated) is analyzed in step S215 of FIG. 2C.

In yet another example provided, RFID access-regulator 100 is configured so that (i) access to data of tag A from outside of faraday cage 110 is permitted for RFID reader X and Y and forbidden for RFID reader Z; (ii) access to data of tag B from outside of faraday cage 110 is permitted for RFID reader Y only and forbidden for RFID readers X and Z. In this example, external RFID interrogation signal indicates some indication of the identity of the RFID reader which generated external RFID interrogation signal. In this example, the decision of step S215 is thus carried out in accordance with a ‘relationship’ between an identity of the RFID tag 120 and an identity of the RFID reader from which external RFID interrogation signal is received.

In another example, the initial RFID interrogation signal does not necessarily include data identifying the RFID reader, but this information is solicited from RFID reader 90 after the initial RFID interrogation signal is reached in a “challenge.”

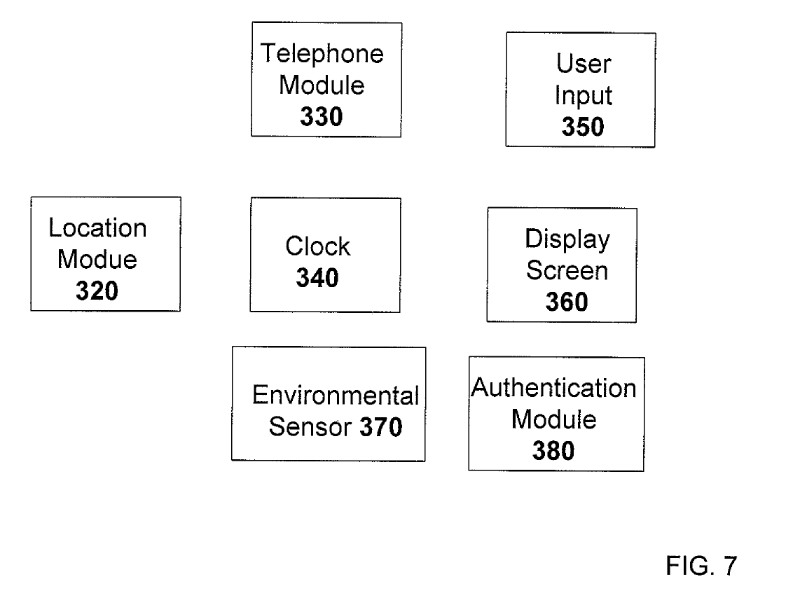

### A Discussion of FIG. 7

In various embodiments, RFID access-regulator 100 may include and/or be operatively linked to at least one of: (i) a location module 320 (for example, GPS module or a location module based upon any); (ii) a clock 340; (iii) a user input 350 (for example, a keyboard or a keypad or a microphone or a touch-screen or any other user input); (iv) an authentication module 380 for authenticating RFID reader 90; (v) an environmental sensor 370 for sensing an ambient environmental parameter (for example, a temperature or a humidity).

In some embodiments, RFID access-regulator 110 effects the determining of S215 in accordance output (for example, an electrical signal) of one or more of the aforementioned elements depicted in FIG. 7.

Also illustrated in FIG. 7 is a display screen which may also be operatively coupled to RFID access-regulator 100. The display screen may be used for any purpose described herein, for example, for soliciting user input about whether access from outside of faraday cage 110 to one or more given RFID tag(s) (or any arbitrary tag) is permitted.

Alternatively or additionally, in some embodiments, display screen may be used for displaying an “inventory” or a list of RFID tag(s) 120 within faraday cage 110. This “inventory information” may be generated by using host port 170 or internal antenna array 130 to interrogate RFID tag(s) within faraday cage 110 in order to detect the presence of the various tags.

It is further noted that any of the embodiments described above may further include receiving, sending or storing instructions and/or data that implement the operations described above in conjunction with the figures upon a computer readable medium. Generally speaking, a computer readable medium may include storage media or memory media such as magnetic or flash or optical media, e.g. disk or CD-ROM, volatile or non-volatile media such as RAM, ROM, etc. as well as transmission media or signals such as electrical, electromagnetic or digital signals conveyed via a communication medium such as network and/or wireless links.

Having thus described the foregoing exemplary embodiments it will be apparent to those skilled in the art that various equivalents, alterations, modifications, and improvements thereof are possible without departing from the scope and spirit of the claims as hereafter recited. In particular, different embodiments may include combinations of features other than those described herein. Accordingly, the claims are not limited to the foregoing discussion.

What is claimed is:

1) A method of selectively facilitating access to RFID data, the method comprising:
a) determining if access to RFID data of one or more RFID tags located in a handheld faraday cage from outside of the faraday cage is permitted;
b) receiving an external RFID interrogation signal; and
c) contingent on determining that the access from outside of the faraday cage is permitted, providing access to the RFID data by:
i) in response to the received external RFID interrogation signal, interrogating inside the faraday the cage one or more RFID tags;
ii) receiving an RFID response from one or more of the interrogated RFID tags; and
iii) transmitting to outside the faraday cage the received RFID response.

2) The method of claim 1 wherein the determining of step (a) is carried out before or in response to the receiving of the external RFID interrogation signal.

3) The method of claim 1 wherein the determining includes authenticating an RFID reader external to the Faraday cage from which the external RFID interrogation signal is received, and a positive determining is contingent on a successful authenticating of the RFID reader.

4) The method of claim 1 wherein the determining is carried out in accordance with at least one of:
i) a location of the Faraday cage;
ii) a time;
iii) a date; and
iv) an ambient environmental factor.

5) The method of claim 1 further comprising:
c) effecting a permitted-forbidden access mode change in response to at least one of:
i) detecting an outgoing phone call;
ii) detecting an outgoing text message;
iii) detecting an incoming phone call; and
iv) detecting an incoming text message,
wherein the determining is carried out in accordance with the changed permitted-forbidden access mode.

6) The method of claim 1 wherein the determining is carried out selectively on a per-tag basis in accordance with RFID data.

7) The method of claim 6 wherein for a given RFID tag located in the handheld faraday cage, the determining is carried out in accordance with a relationship between an identity of the given RFID tag and an identity of an RFID reader external to the faraday cage from which the external RFID interrogation signal is reached.

8) The method of claim 7 wherein:
i) the method further comprises:
d) in the event that the external RFID interrogation signal is directed to a given one or more RFID tags within the handheld faraday cage, soliciting an RFID reader identifier from a source of the external RFID interrogation signal; and
ii) the determining of step (a) is carried out in a manner that is contingent upon receiving, in response to the soliciting, an RFID reader identifier that matches a set of permitted RFID readers for the given one or more RFID tags.

9) The method of claim 6 wherein the determining includes, for a given RFID reader, permitting access to a first sub-set of a plurality of RFID tags located in the handheld faraday cage, and forbidding access to a second sub-set of the plurality of RFID tags located in the handheld faraday cage.

10) The method of claim 1 wherein the determining is carried out in a manner that is insensitive to a tag identifier.

11) The method of claim 1 wherein the determining is carried out in a manner that is insensitive to an identifier of an RFID reader from which the external RFID interrogation signal is received.

12) The method of claim 1 further comprising:
d) effecting a permitted-forbidden access mode change in response to a receiving of user input via one or more user controls;
wherein the determining is carried out in accordance with the changed permitted-forbidden access mode.

13) The method of claim 12 wherein the user input is tag-specific user input and the access mode change is carried out only for the set of one or more tags specified in the tag-specific user input.

14) The method of claim 1 further comprising:
d) determining an inventory of one or more RFID tags residing within the handheld faraday cage; and
e) presenting to a user a description of the inventory.

15) The method of claim 1 wherein:
i) the method further comprises:
d) in response to the received external RFID interrogation signal, soliciting user input from a user; and
ii) the determining of step is carried out in accordance with the solicited user input.

16) The method of claim 1 wherein:
i) the interrogating, inside the faraday cage, includes transmitting an internal interrogation signal to one or more of the RFID tags within the handheld faraday cage using an internal antenna assembly; and
ii) the response receiving is carried out using the internal antenna assembly.

17) The method of claim 1 wherein the interrogating inside the faraday cage and the response receiving are carried out using a device port that is:
i) deployed internally within the faraday cage; and
ii) wired to one or more of the RFID tags.
